(19) United States
(12) Patent Application Publication
(10) Pub. No.: US 2014/0195349 A1
(43) Pub. Date: Jul. 10, 2014

(54) METHOD AND SYSTEM FOR DISTRIBUTING TARGETED ADVERTISING AND INTUITIVE WAYFINDING

(71) Applicant: MallWise, LLC, Houston, TX (US)

(72) Inventors: Scott Muster, Houston, TX (US); William V. Bay, JR., Katy, TX (US); Jesse Mills, Houston, TX (US)

(73) Assignee: MallWise, LLC, Houston, TX (US)

(21) Appl. No.: 13/963,047

(22) Filed: Aug. 9, 2013

Related U.S. Application Data
(63) Continuation of application No. 12/841,825, filed on Jul. 22, 2010, now abandoned.
(60) Provisional application No. 61/227,477, filed on Jul. 22, 2009.

(51) Int. Cl. G06Q 30/02

(52) U.S. Cl. CPC G06Q 30/0261
USPC 705/14.58

(57) ABSTRACT

The present invention is a method for displaying messaging, wayfinding and advertising on interactive kiosks and digital wireless communication devices including handheld portable devices within a Wireless Local Area Network (WLAN) or through the Internet. The information is stored in databases connected to the Internet that include maps of shopping centers or malls, data regarding user profiles, product categories and product brands which provide users the ability to search the database and interact with the maps and point-of-purchase advertising. When proximity-based WLAN access is available, the data is merged with more data concerning the user's relative position within the network.

### CROSS REFERENCE TO RELATED APPLICATION

This application is a continuation in part of U.S. Non-Provisional application Ser. No. 12/841,825 filed on Jul. 22, 2010 which and entitled “METHOD AND SYSTEM FOR DISTRIBUTING TARGETED ADVERTISING AND INTUITIVE WAYFINDING” claims the priority of U.S. Provisional application Ser. No. 61/227,477, filed on Jul. 22, 2009, and entitled “METHOD AND SYSTEM FOR DISTRIBUTING TARGETED ADVERTISING AND INTUITIVE WAYFINDING.” Said applications incorporated herein for all purposes and in its entirety.

### FIELD

This invention generally relates to advertising and specifically to the delivery and distribution of highly targeted point-of-purchase advertising and wayfinding.

### DESCRIPTION OF THE RELATED ART

The advertising industry is facing a radical transformation—one that many participants are under-prepared for in terms of its technological and cultural impact. The transformation is moving relatively quickly but will take many years to reach the next level. Print advertising is declining, digital advertising is increasing. Advertisers need to focus their efforts on three screens: the computer, the TV and the portable device.

Demographic changes (Baby Boomers opposed to Gen X and Y), the accelerating pace of change and the adoption rate of technology are three of the big drivers behind this transformation. Other drivers include what advertisers need from their advertising—more performance (targeting), efficiency, convenience, flexibility, accountability and scalability.

The cultural impact includes the way we shop and interact with advertising. To many, shopping has been considered a recreational activity in which a shopper visits a variety of stores interacting with the shopping community that includes store personnel and other shoppers. Point of purchase advertising targeted at window shoppers consists of signage and messaging—how well it works is subject to speculation. In fact, typical advertising has very few, if any metrics to support claim to ROI (Return on Investment).

To some, shopping is a task of inconvenience and vexation. Big shopping centers and malls intimidate some shoppers because of the time involved and the unknowns regarding where a particular store or brand is located. Knowing where to park and how to find the store or a brand of products would enhance the shopping experience and lessen the anxiety.

Online shopping has been rising at a rate that threatens the existence of shopping centers and brick-and-mortar stores. Many malls are on the brink of bankruptcy. Online shopping is perceived to be efficient; however, when shipping costs and returns are factored in, efficiency is greatly diminished. Online shopping has two powerful weaknesses: no immediate gratification and the lack of community.

As with the advertising industry, the communication industry is facing a similar transformation of its own where users are increasingly accessing the Internet, wide-area networks (WANs) and local area networks (LANs) with devices such as personal computers (PCs), personal digital assistants (PDAs), portable digital media players and mobile phones. Portable devices, in particular, are growing in capabilities and popularity. Various venues, protocols and techniques are used with all of these devices.

With all of the networks available, users generally have good connectivity and the ability to interact with digital media in almost any part of North America and the World. Retail establishments and public areas are increasingly making WLANs available for the purpose of interacting with users to conduct marketing/advertising activities and ecommerce in some form. Potential increases in sales and the benefits of performance advertising are very attractive outcomes for retailers and operators of malls and shopping centers who leverage the transformations that are happening in advertising and communication technologies.

Therefore, there are powerful driving forces and competition to provide customizable, wireless services that operate within these networks. Advertising targeted messaging to the physical location of the user while they are in the vicinity of the retail establishment is potentially the most powerful sales incentive, however, not all of the user's devices have that capability, so a fully integrated, multi-level system needs to be designed to address today's needs and state-of-technology—this is a significant engineering challenge.

Existing mall/retail point-of-purchase advertising methods employ “shotgun” style ads, meaning they are broad and not targeted to an individual shopper's needs or desires. These methods are also “push” advertising, meaning they intrude upon a shopper's attention without providing an incentive for the shopper's consideration. No one has deployed a successful method of targeted “pull” advertising which allows a shopper to shape the advertising they see and provides an incentive for viewing the advertising.

In addition, much of existing advertising delivery hardware (such as printed or digital signage) is singular in function so they can require more floor space to deploy. This uses valuable mallway real estate that could be leased to retail vendors.

Other methods to integrate technology into brick and mortar shopping centers essentially turn the process into online shopping with instant product delivery. These methods ignore the fact the majority of mall shoppers consider the physical aspect of shopping an enjoyable and social experience.

### SUMMARY OF THE INVENTION

The following description is not to be taken in a limiting sense, but is made for the purpose of describing the general principles of the present disclosure. The scope of the present disclosure should be determined with reference to the claims.

The present invention is a high-value business methodology whereby shoppers are provided useful services such as store directories, maps, and/or wayfinding in conjunction with targeted point-of-purchase advertising. The system can deliver both “push” and “pull” advertising. It is a comprehensive and integrated system that consolidates hardware usage and allows shopping centers or malls to deploy the system in tiers depending upon their budgets.

### Tier One

FIG. 1A—Interactive Kiosks/Digital Signage—Shoppers without portable devices 12 and those with some disabilities will be able to use the kiosks. Positioned throughout the mall, the stationary interactive kiosks 14 use touchscreen technology to interact with users and provide search, wayfinding and advertising 16. Metrics on searches and advertising are available to the advertisers. When not being used as directories, the kiosks double as digital signage for additional mall advertisements and community building.

### Tier Two

FIG. 1B—Portable Device with Internet access—Mall directories are available to users from a website with search, mapping and advertising capabilities 26, 34. Advertisers are provided sophisticated metrics. Users can access the information via the portable device's mobile web browser 24 or a dedicated application 32 written for that device's operating system (OS). The native application may utilize additional features supported by the particular portable device's OS 36. Internet access can be through a cellular/mobile phone service provider 28, 30, LAN/WAN access 20, 22 or any other means that a device may use to browse the Internet.

### Tier Three

FIG. 1C—Portable Device using an Installed Proximity WLAN System—A Proximity based WLAN 42 such as the Cisco Wireless Location Appliance installed in the mall provides proximity data about shoppers with Wi-Fi capable portable devices 40 (location of the user relative to each store in the mall) and enhances the user's experience with interactivity, wayfinding and point-of-purchase advertising 48, 52 that can be tailored to the user's personal profile. Utilizing a proximity based WLAN, a mall or shopping center can be a predefined service region and may be sub-divided into a number of physically or logically defined sub-regions that correspond to individual retail locations. Metrics available through this application can be extensive and powerful providing personal profiles and buying tendencies. Users can access the information via the portable device's mobile web browser 46 or through a dedicated application written for that portable device's OS 50. The native application may utilize additional features supported by the particular device's OS 54.

The system delivers two categories of content:

“Search based Content” is context sensitive and essentially “pull” advertising. Mall Directory, Map, and Advertising are pulled to the user based upon the subject matter of user's search query. For example, a search for shoes or a particular shoe store will return context sensitive Ads for shoes, not power tools.

“Proximity based Content” is location sensitive and essentially “push” advertising. Mall Directory, Map, and Advertising are pushed out to the user's location within the mall when a proximity-based WLAN is in place. In addition to proximity information, the Ad results can also be refined by contextual information (Search based Content) and the User Feedback system discussed later. These interactions turn the proximity based content into “pull” advertising.

The integrated system blends online and traditional shopping; simultaneously enhancing the shopper's experience with community, wayfinding and immediate gratification. Additionally, the system improves the effectiveness of storekeeper's point-of-purchase (POP) advertising and provides valuable data that can be analyzed for more precise ROI and valuable trending.

The tiered format as described above combined with advertising auctions and micropayment pricing schedules similar to Google, provides the mall operator and the advertisers flexibility and scalability by providing the opportunity to optimize their budget, the user/shopper profile/demographics and local state-of-technology. No shopper is left out of the equation, with or without WIFI connectivity.

The mall operator also has access to a new revenue stream from advertising profit-sharing programs. The cost of installing the invention's technology will be offset by advertising revenue, thereby, eliminating or dramatically reducing the resistance to adopting this new technology and advertising channel. The scalability of the system can include integrating digital signage and office directories with mall directories and the advertising system (in a mixed use property). Furthermore, a security system can be added including video cameras, an integrated alert messaging system, and shopper traffic data to provide more value.

The invention provides value to stakeholders by providing content as the result of the invention's search functionality in the form of mall maps and wayfinding. Integrating the advertising with valuable content will alleviate some of the concerns about “too many ads”.

Loyalty programs may be included as part of the invention as well, providing user rewards for shopping through the invention's system. Customer loyalty is the result of well-managed customer retention programs; customers who are targeted by a retention program demonstrate higher loyalty to a business. In addition, the customer loyalty program will provide personal profiles and shopping trends to the advertisers; valuable data that will translate into more precise market insights and better, more targeted performance advertising.

Consumer profiles gathered through the communication devices and stored in databases may be used in a variety of ways including the identification of favored retail locations, customized user interfaces, purchasing interests and trends, and search words that will lead to better targeting of performance advertising while enhancing the user's experience.

This summary is provided to introduce the invention's features and capabilities. The concepts are further described in the Detailed Description section. These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGUREs and detailed description. It is intended that all such additional systems, methods, features and advantages that are included within this description, be within the scope of the claims.

### BRIEF DESCRIPTIONS OF THE DRAWINGS

The present subject matter will now be described in detail with reference to the drawings, which are provided as illustrative examples of the subject matter so as to better enable those skilled in the art to practice the subject matter. Notably, the figures and examples are not meant to limit the scope of the present subject matter to a single embodiment, but other embodiments are possible by way of interchange of some or all of the described or illustrated elements and, further, wherein:

FIGS. 1A, 1B and 1C show, respectively, Tier 1, Tier 2 and Tier 3 of the tiered methods to access the network depending upon the hardware available to the user and consequently the type of information that can be provided to the user.

FIG. 1D shows a key for the graphics utilized for all of the Figures.

FIG. 2 illustrates an exemplary computing system and related peripherals that may be used in conjunction with the disclosed subject matter.

FIG. 3 illustrates a process flow for a kiosk to deliver self promotion and advertising messages when not currently being engaged for searches and queries in one embodiment of the disclosed subject matter.

FIGS. 4A, 4B and 4C illustrate a process flow for a user using a kiosk in one embodiment of the invention.

FIG. 5 illustrates a process flow for the feedback process of the disclosed subject matter.

FIGS. 6A, 6B and 6C illustrate a process flow for a portable device user who has connected to the network using a mobile phone provider when no wireless LAN or proximity-based wireless LAN is available in one embodiment of the disclosed subject matter.

FIGS. 7A, 7B, 7C and 7D illustrate a process flow for a typical user experience with a portable device but without proximity based WLAN in one embodiment of the disclosed subject matter.

FIG. 8 illustrates a process flow for the shopping cart feature in one embodiment of the disclosed subject matter.

FIG. 9 illustrates a typical user experience with a portable device an proximity based WLAN in one embodiment of the disclosed subject matter.

FIGS. 10A, 10B, 10C and 10D illustrate a process flow for a portable device user in conjunction with a proximity based WLAN in one embodiment of the disclosed subject matter.

FIG. 11 illustrates the general system architecture of the disclosed subject matter.

FIG. 12 illustrates a flow diagram of the ad management system of in one embodiment of the disclosed subject matter.

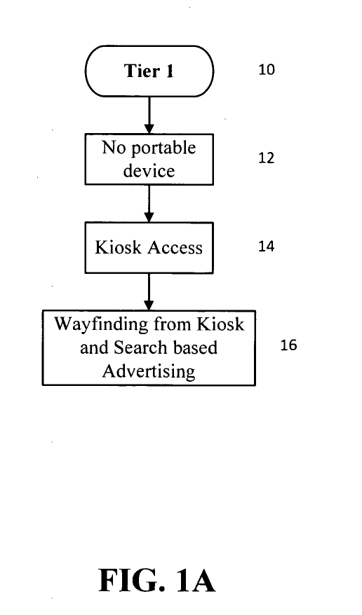

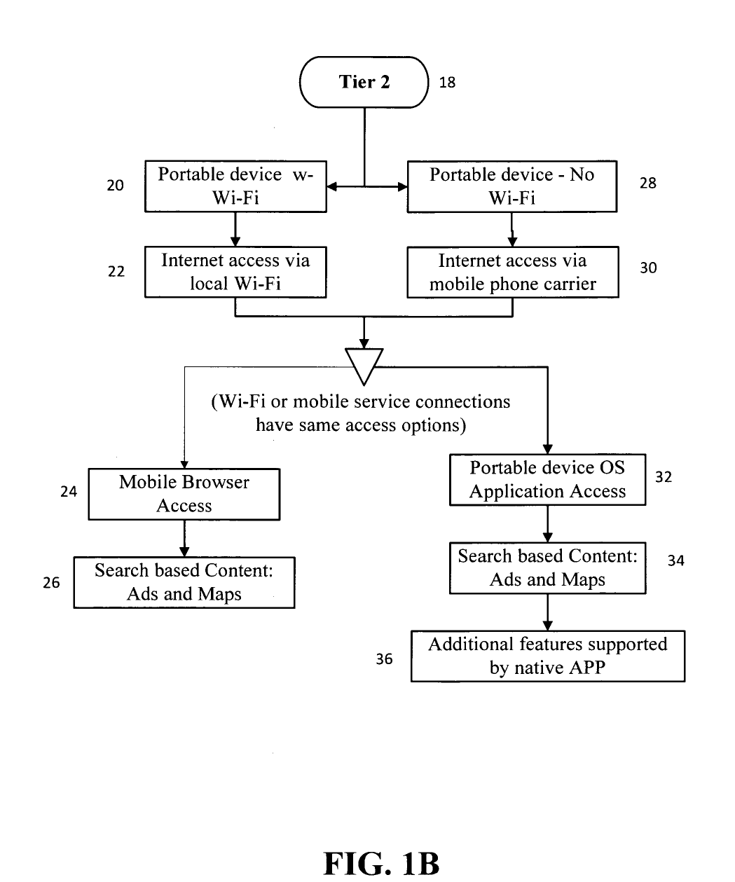

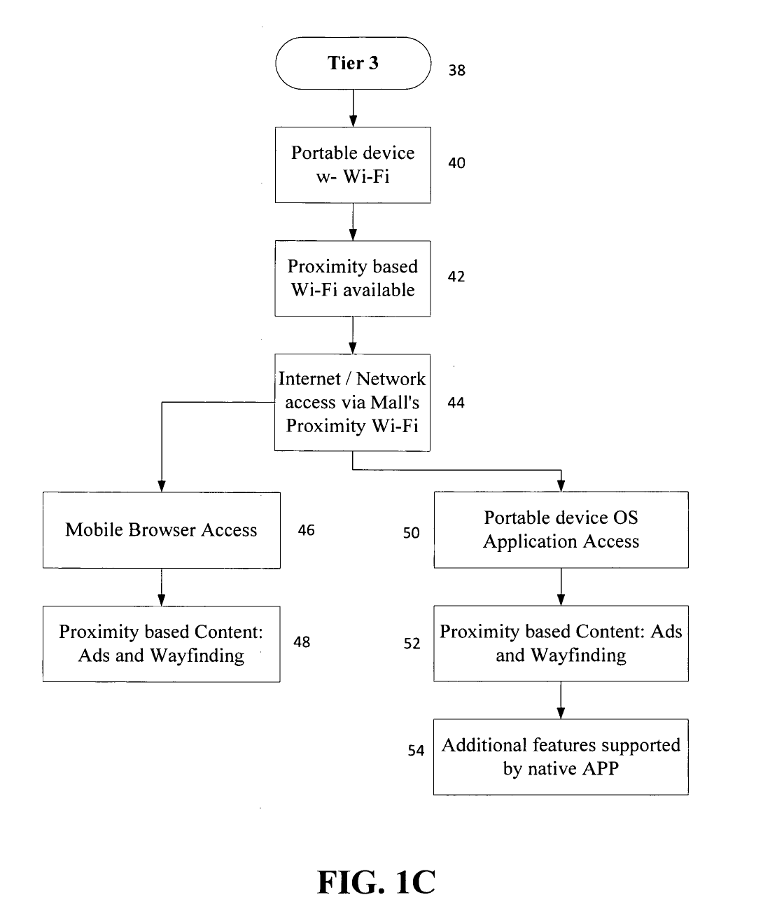

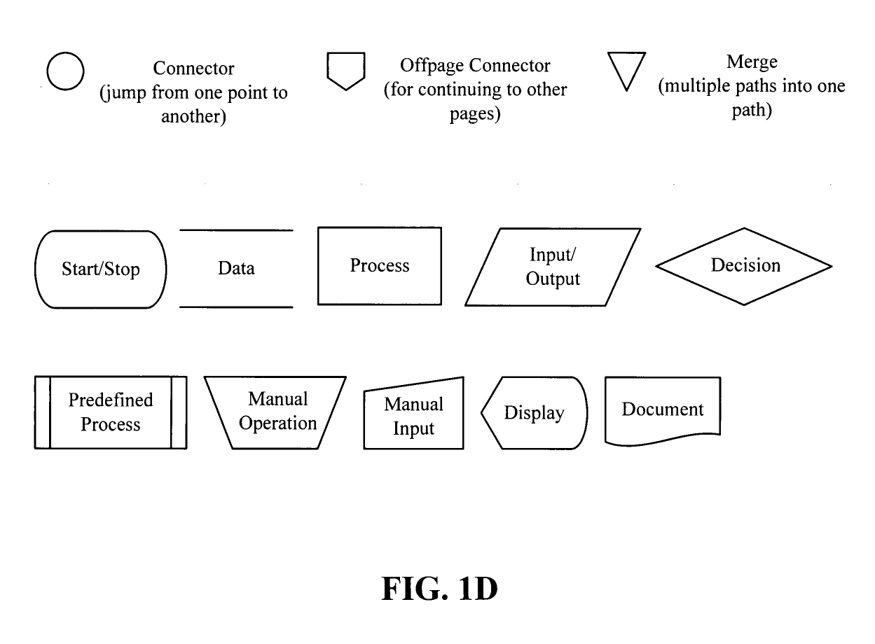

### DETAILED DESCRIPTION OF THE INVENTION

In the present specification, an embodiment showing a singular component should not be considered limiting. Rather, the subject matter encompasses other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present subject matter encompasses present and future known equivalents to the known components referred to herein by way of illustration.

Throughout this disclosure the words “shopper” and “user” describe the customer and/or user and are used interchangeably unless the context clearly indicates a different meaning. Additionally, unless the context clearly indicates a different meaning, handheld portable device and portable device are intended to include, but are not limited to, cell phones, PDAs (Personal Digital Assistants), MDAs (Mobile Digital Assistants, smart phones, netbooks, tablet PCs, tablet devices, multi-touch devices, etc., and the two words are used interchangeably throughout the disclosure. Broadcast Ad generally means a large, full screen ad that can be pushed out while certain features are loading. Sponsor Ad generally means thumbnail ads that are a part of the search process. Detail Ad—more robust ads that are a part of the search process. Transactional data may include one or more maps, directions, coupons with barcode that can be read at register, and/or any other details needed by the shopper or the retailer to complete a transaction. The words Ad and advertisements are used interchangeably through out the disclosure.

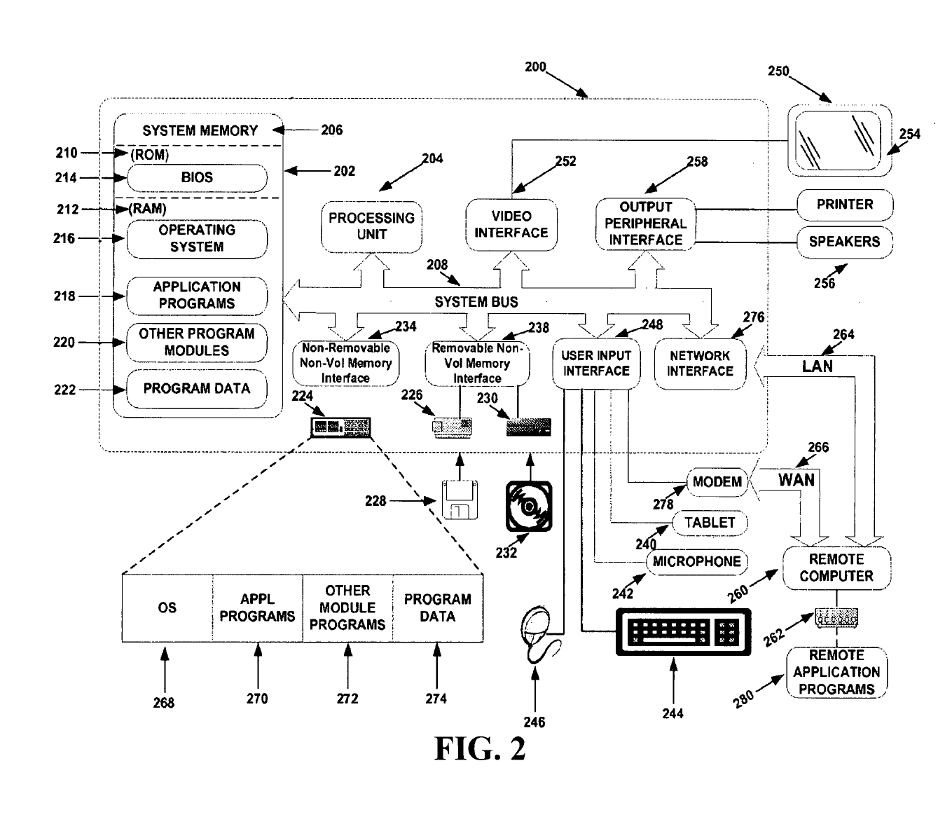

With reference to FIG. 2, an exemplary system within a computing environment for implementing the invention includes a general purpose computing device in the form of a computing system 200, commercially available from Intel, IBM, AMD, Motorola, Cyrix and others. Components of the computing system 202 may include, but are not limited to, a processing unit 204, a system memory 206, and a system bus 236 that couples various system components including the system memory to the processing unit 204. The system bus 236 may be any of several types of bus structures including a memory bus or memory controller, a peripheral bus, and a local bus using any of a variety of bus architectures.

Computing system 200 typically includes a variety of computer readable media. Computer readable media can be any available media that can be accessed by the computing system 200 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data.

Computer memory includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing system 200.

The system memory 206 includes computer storage media in the form of volatile and/or nonvolatile memory such as read only memory (ROM) 210 and random access memory (RAM) 212. A basic input/output system 214 (BIOS), containing the basic routines that help to transfer information between elements within computing system 200, such as during start-up, is typically stored in ROM 210. RAM 212 typically contains data and/or program modules that are immediately accessible to and/or presently being operated on by processing unit 204. By way of example, and not limitation, an operating system 216, application programs 220, other program modules 220 and program data 222 are shown.

Computing system 200 may also include other removable/non-removable, volatile/nonvolatile computer storage media. By way of example only, a hard disk drive 224 that reads from or writes to non-removable, nonvolatile magnetic media, a magnetic disk drive 226 that reads from or writes to a removable, nonvolatile magnetic disk 228, and an optical disk drive 230 that reads from or writes to a removable, nonvolatile optical disk 232 such as a CD ROM or other optical media could be employed to store the invention of the present embodiment. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 224 is typically connected to the system bus 236 through a non-removable memory interface such as interface 234, and magnetic disk drive 226 and optical disk drive 230 are typically connected to the system bus 236 by a removable memory interface, such as interface 238.

The drives and their associated computer storage media, discussed above, provide storage of computer readable instructions, data structures, program modules and other data for the computing system 200. For example, hard disk drive 224 is illustrated as storing operating system 268, application programs 270, other program modules 272 and program data 274. Note that these components can either be the same as or different from operating system 216, application programs 220, other program modules 220, and program data 222. Operating system 268, application programs 270, other program modules 272, and program data 274 are given different numbers hereto illustrates that, at a minimum, they are different copies.

A user may enter commands and information into the computing system 200 through input devices such as a tablet, or electronic digitizer, 240, a microphone 242, a keyboard 244, and pointing device 246, commonly referred to as a mouse, trackball, or touch pad. These and other input devices are often connected to the processing unit 204 through a user input interface 248 that is coupled to the system bus 208, but may be connected by other interface and bus structures, such as a parallel port, game port or a universal serial bus (USB).

A monitor 250 or other type of display device is also connected to the system bus 208 via an interface, such as a video interface 252. The monitor 250 may also be integrated with a touch-screen panel or the like. Note that the monitor and/or touch screen panel can be physically coupled to a housing in which the computing system 200 is incorporated, such as in a tablet-type personal computer. In addition, computers such as the computing system 200 may also include other peripheral output devices such as speakers 254 and printer 256, which may be connected through an output peripheral interface 258 or the like.

Computing system 200 may operate in a networked environment using logical connections to one or more remote computers, such as a remote computing system 260. The remote computing system 260 may be a personal computer, a server, a router, a network PC, a peer device or other common network node, and typically includes many or all of the elements described above relative to the computing system 200, although only a memory storage device 262 has been illustrated. The logical connections depicted include a local area network (LAN) 264 connecting through network interface 276 and a wide area network (WAN) 266 connecting via modem 278, but may also include other networks. Such networking environments are commonplace in offices, enterprise-wide computer networks, intranets and the Internet.

The central processor operating pursuant to operating system software such as IBM OS/2®, Linux®, UNIX®, Microsoft Windows®, Apple Mac OSX® and other commercially available operating systems provides functionality for the services provided by the present invention. The operating system or systems may reside at a central location or distributed locations (i.e., mirrored or standalone).

Software programs or modules instruct the operating systems to perform tasks such as, but not limited to, facilitating client requests, system maintenance, security, data storage, data backup, data mining, document/report generation and algorithms. The provided functionality may be embodied directly in hardware, in a software module executed by a processor or in any combination of the two.

Furthermore, software operations may be executed, in part or wholly, by one or more servers or a client's system, via hardware, software module or any combination of the two. A software module (program or executable) may reside in RAM memory, flash memory, ROM memory, EPROM memory, EEPROM memory, registers, hard disk, a removable disk, a CD-ROM, DVD, optical disk or any other form of storage medium known in the art. An exemplary storage medium is coupled to the processor such that the processor can read information from, and write information to, the storage medium. In the alternative, the storage medium may be integral to the processor. The processor and the storage medium may also reside in an application specific integrated circuit (ASIC). The bus may be an optical or conventional bus operating pursuant to various protocols that are well known in the art.

Data shared and/or used in the various embodiments can also be shared and/or used via a traditional web site or to populate a web site (or other medium). This allows information already assembled in one or more of the other embodiments to be repurposed and thereby raise the value of the disclosed subject matter.

### Tier 1—Interactive Kiosks/Digital Signage Application:

Digital Signage

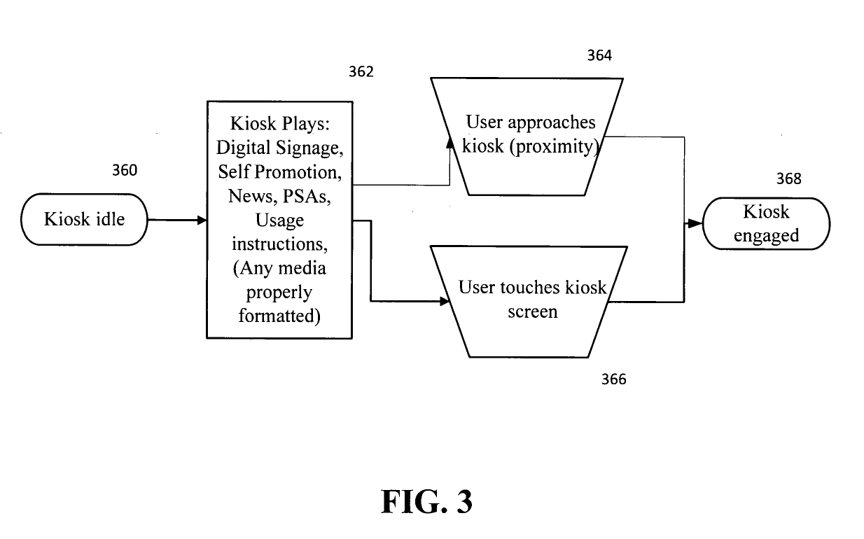

As illustrated in FIG. 3, Self-promotion 362 of the directory runs on the kiosk while the program is not engaged by a user 360. Example messaging: “Looking for something? Find it here!”, “Can't find the store you're looking for? Touch the screen!”

Directory kiosks will also double as digital signage 362 when not doing self promotion, thereby consolidating mall directory hardware and signage hardware.

Digital signage Ads can be any medium (video, animation, graphic still) that can be supported by the hardware.

Engaging the Kiosk

A shopper just has to touch the screen 366 to bring up the mall directory interface 368. Proximity sensors can also be used to activate the directory when a user is near 364. To accommodate handicap/wheelchair shoppers, either multiple kiosks could be employed at different heights or a handicap button could be implemented that would move all of the Ads to the lower portion of the screen for easier access.

Search/Wayfinding

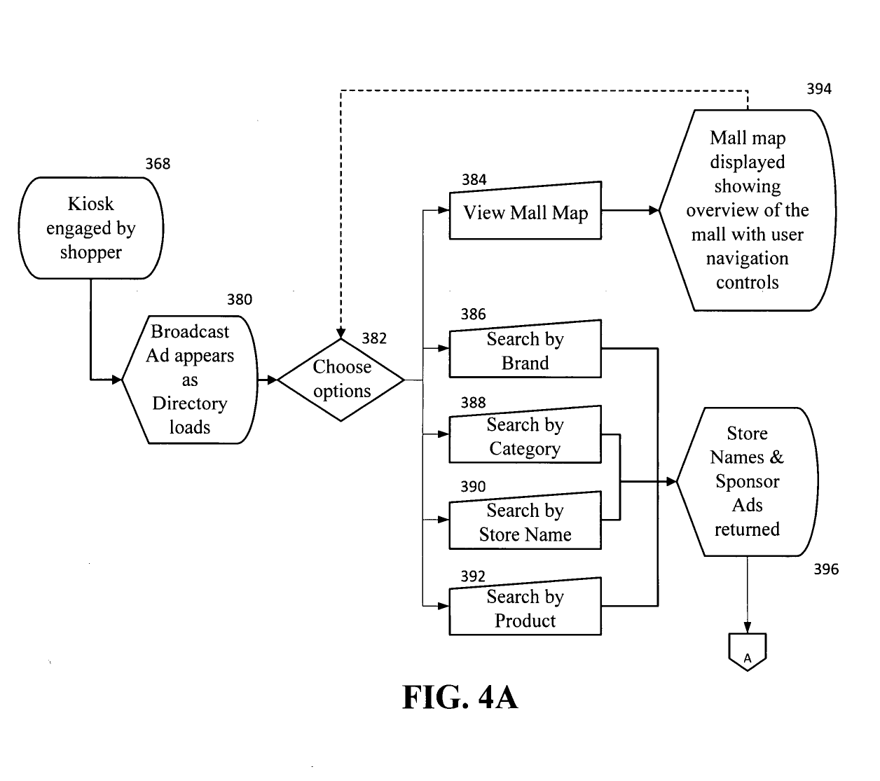

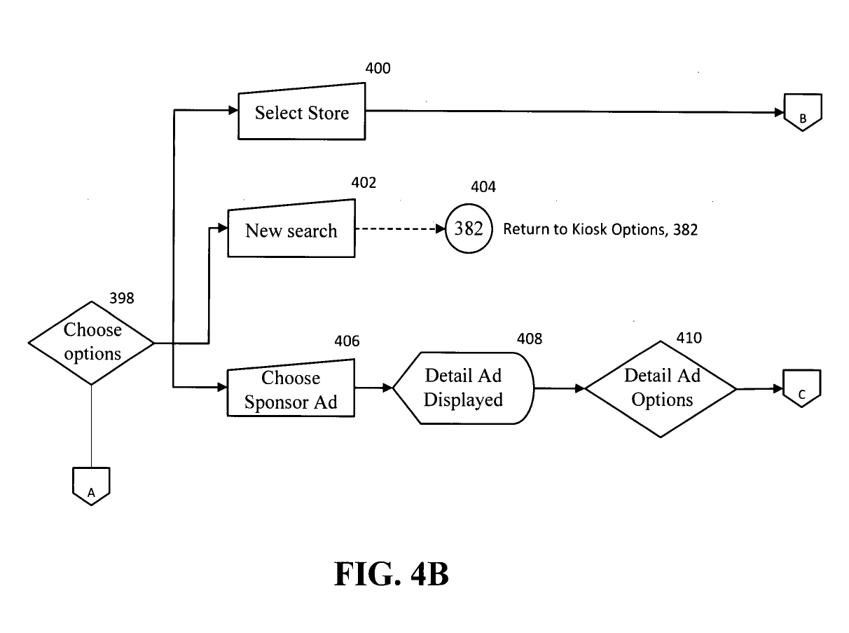

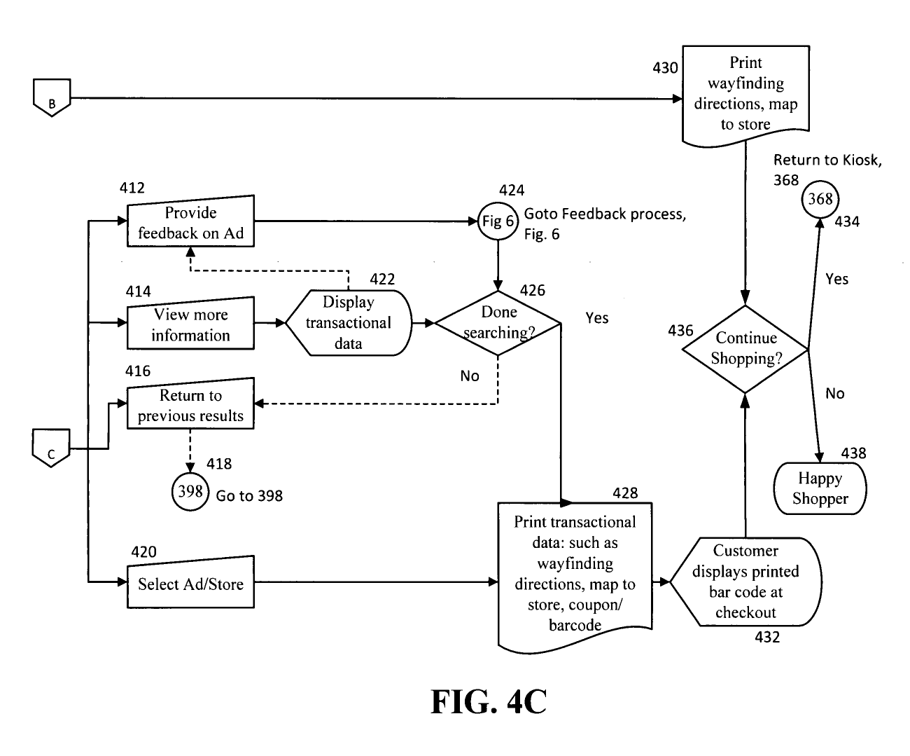

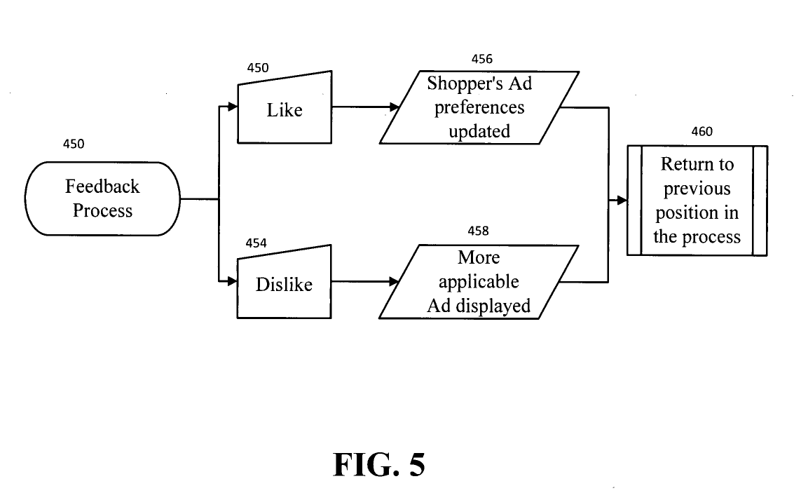

Referring to FIGS. 4A, 4B and 4C, the mall directory and map are central to the system's functionality and will provide intuitive guidance to find a store's location in the mall. Searches can be conducted in four categories: brand, store names, category of merchandise, individual product. The search process:
The user chooses what they are looking for from the possible selections 382 and the screen changes to reflect the selection.
   Brand 386—The stores where that brand is located are listed/highlighted. Stores that are participating in the Sponsor Ad campaign also have a thumbnail ad appear that includes store branding.
   Categories of merchandise 388—Multiple stores are listed/highlighted. Stores that are participating in the Sponsor Ad campaign also have a thumbnail ad appear that includes store branding.
   Store names 390—The store location is highlighted. Stores that are participating in the Sponsor Ad campaign also have a thumbnail ad appear that includes store branding.
   Products 392—An interactive touchscreen or keyboard is activated. As the user enters each letter, a list of potential search results is revealed on the screen. In an alternative embodiment, a traditional keyboard/mouse may be used.
   Alternatively a user may navigate to a large screen version of the mall map 384, with traditional/familiar electronic map navigation controls 394.
   When the technology is available for practical widespread deployment, voice recognition, multi-touch tables/screens, or motion controls that can sense motion without requiring touching, may be used.
“Search based Content”—Context sensitive Directory, Map, and Advertising results are returned 396.
“Wayfinding”—Select a listed/highlighted store and a wayfinding map and directions are provided 400. The output is similar to the “driving directions” on mapping programs such as Google® (a registered trademark of Google, Inc.) Maps or MapQuest® (a registered trademark of MapQuest.com, Inc.)—an arrow on the mall map shows the route to the store's location from the kiosk location along with simple directions. Additionally, the user would be able to get a printed list of the directions and/or a map graphically depicting the directions 430. The user can perform a new search 402, 404 if the results are not satisfactory.
Choose a Sponsor Ad 406 and the kiosk transforms to a larger, more robust Detail Ad 408 which can include brand messaging, imagery and details on exclusive offerings. The shopper can make a number of choices 410:
The shopper can immediately return 416, 418 to the previous search results 398 if they do not like the Detail Ad.
The shopper can immediately select the Detail Ad 420 and print all the Transactional data 428 associated with the search.
Or the user can review 414 any of the Transactional data 422 for that offer if they want more information.
When the user is done searching 426, the kiosk can print all the associated Transactional data 428. Even if the user did not respond to an Ad, an advertiser can elect to have a promotional coupon printed on the wayfinding map and directions.
The transactional data bar code can be used at the register 432 to complete the sale. From there the shopper can continue shopping 436, 434 or leave happy 438.
Feedback 412, 424—Referring to FIG. 5, at many points during the search process, feedback 450 can be provided on one or more types of Ads:
   “Like” 452—If the user likes the Ad then the visitor's session profile will be updated 456 to show more applicable ads on other queries.
   “Dislike” 454—If the user dislikes the Ad then it will be immediately replaced with a more applicable Ad 458 if one is available.
   When leaving feedback, the user interface may not need to change at all, but regardless the user is always returned to the place where he/she started 460.
The feedback data will be cleared when a user prints any transactional data, or after a certain amount of time to allow for new users.

Metrics

Kiosk metrics provided to advertisers include, but are not be limited to:
How many times a store comes up in search results.
How many times users chose Sponsor Ads and which Ads are chosen.
How many times users chose Detail Ads and which Ads are chosen.
How many coupons were printed (Transactional data). Data on Coupon bar codes can be merged with a store's transaction data for precise analysis on ROI and trending.
Conversion rate on an Ad series: Sponsor Ad->Detail Ad->Transactional data to determine campaign effectiveness.
Search terms (keywords) used.
Activity trends such as hours of the day, day of the week, etc.
Activity levels of the kiosks.
   Tier 2—Portable Device with Internet Access

Engaging the System

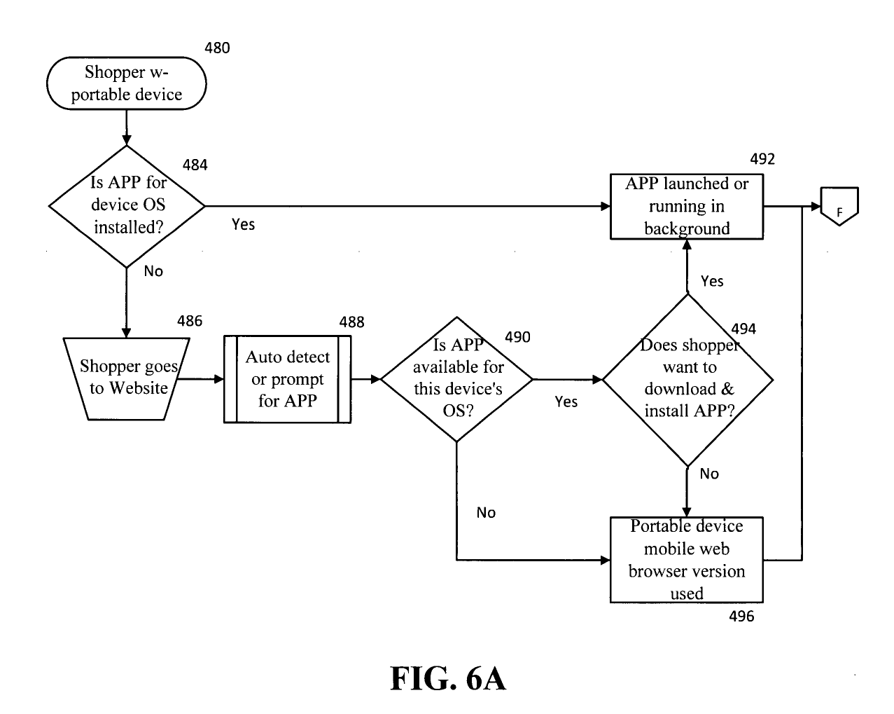

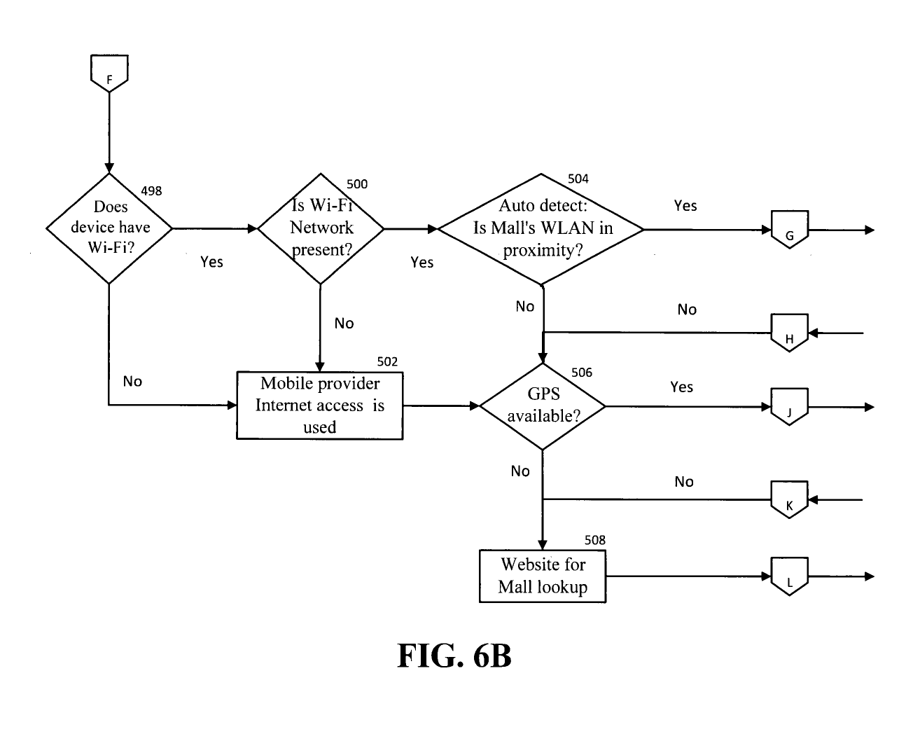

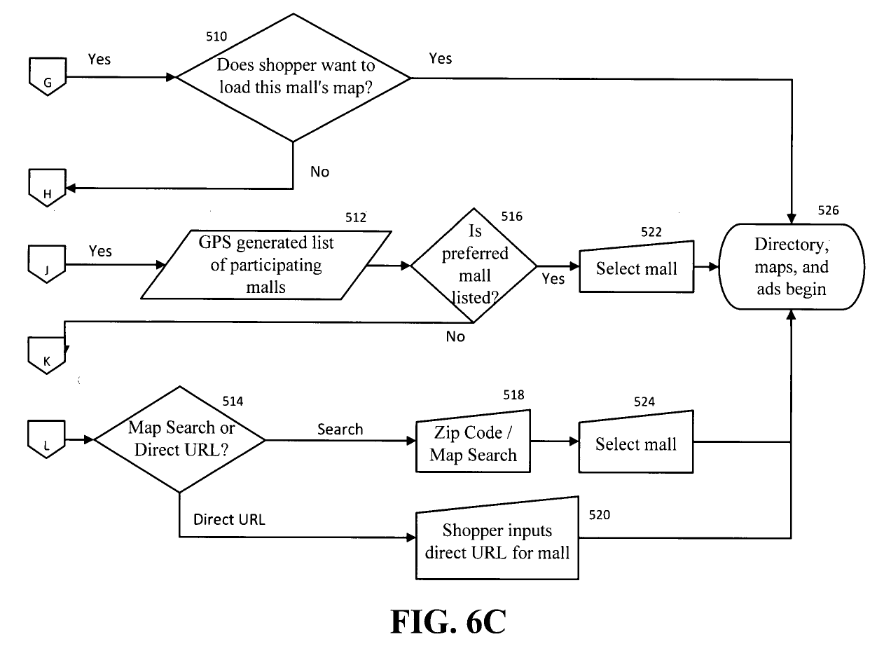

FIGS. 6A, 6B and 6C show how the user can engage the system. The user 480 launches a dedicated application (APP) if available 484. A dedicated APP 492 will be used for enhancing the user interface as opposed to the mobile browser version. Or the user launches the portable device's web browser and goes to the website 486. When accessing the website with a mobile browser, the user may be prompted 488 to download a dedicated APP for their portable device if one is available 490. If an APP is not available 496 or the user decides not to download it 494, they can proceed using the mobile browser version 496.

Whether the shopper is using the mobile browser version or a dedicated APP, the look up process will follow: The APP 498 will check for available open WiFi networks 500 and proximity-based WiFi Networks 504. If no proximity-based WiFi network is available, the invention will use a local WiFi connection or default to the mobile device provider's Internet service 502. If a proximity-based WLAN is in place, the user will be prompted to load the directory/map for that mall 510.

If the user declines to load the mall from a proximity-based WLAN or there is not proximity-based WLAN available 506, GPS equipped portable devices will locate the user and present a list of malls in the area 512. If the GPS list does not present the user desired results, or if GPS is not available, the user can perform a traditional location search 508, by entering a zip code 518 or other pertinent geographical information and retrieve a list of malls in the area.

Alternately 514, the user can input a direct URL 520. As a user approaches the mall entrance, advertising/signage on doorways will prompt users to go to a website URL specific for that Mall 520.

After using any of the methods to find the mall of their choice, the user will make a selection 522, 524 and the mall's information will load 526. A Broadcast Ad comes on the screen while the directory and map are loading.

Search/Mapping

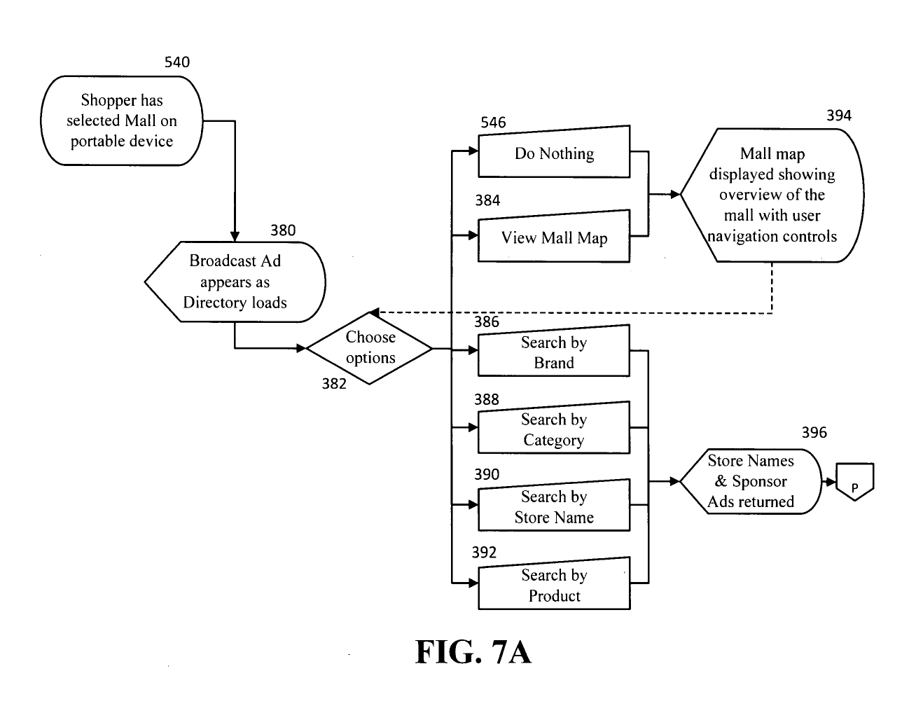

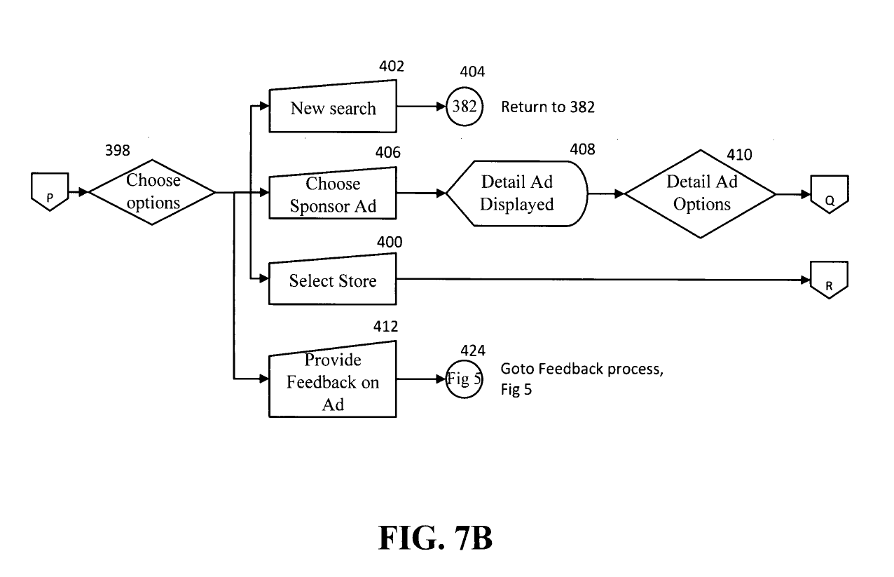

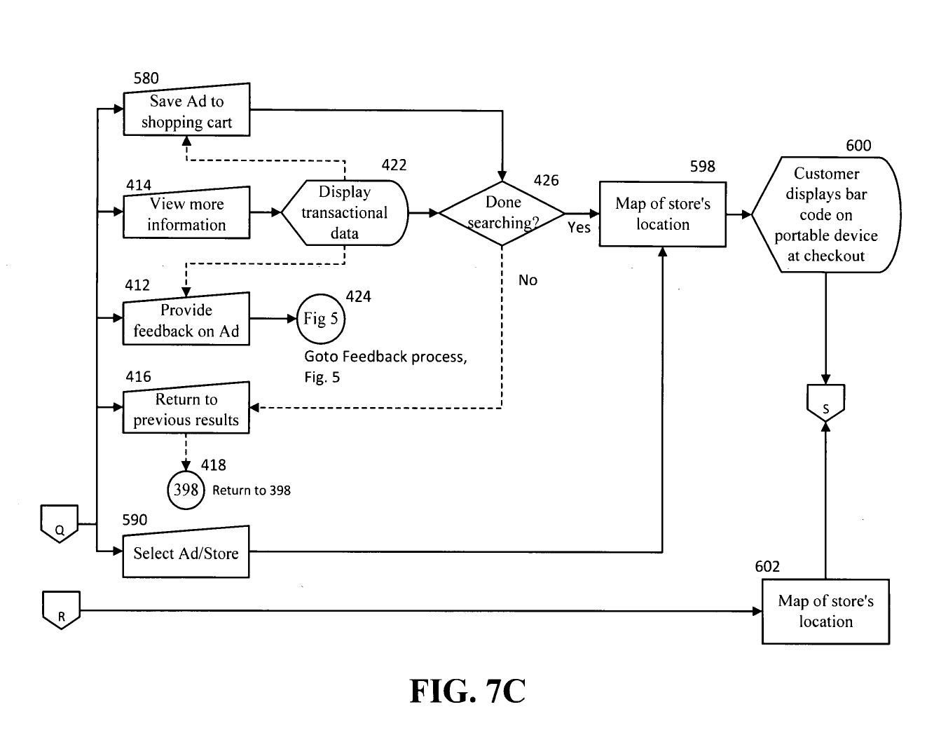

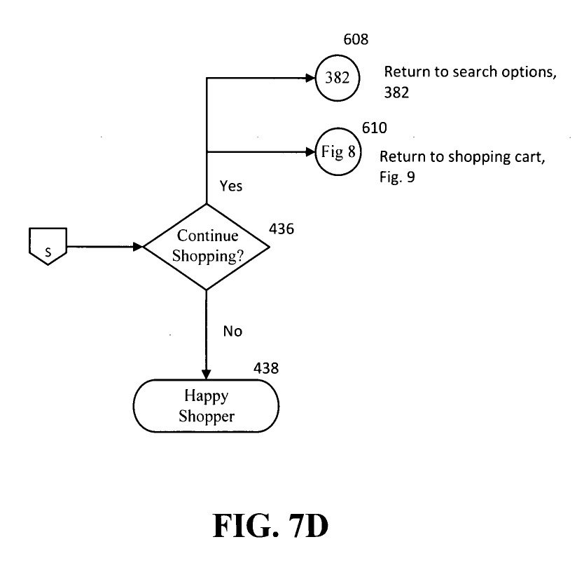

FIGS. 7A, 7B, 7C and 7D show a typical user experience. The mall directory and map function are similar to the kiosk interface but optimized for mobile delivery. Searches can be conducted in the same categories and search based content will be returned just as with the kiosk. The shopper will also interact with Ads similar to the kiosk. Items previously discussed with reference to FIGS. 4A-4C (for Tier 1 access) will not be rediscussed even though they may appear in FIGS. 7A-7D.

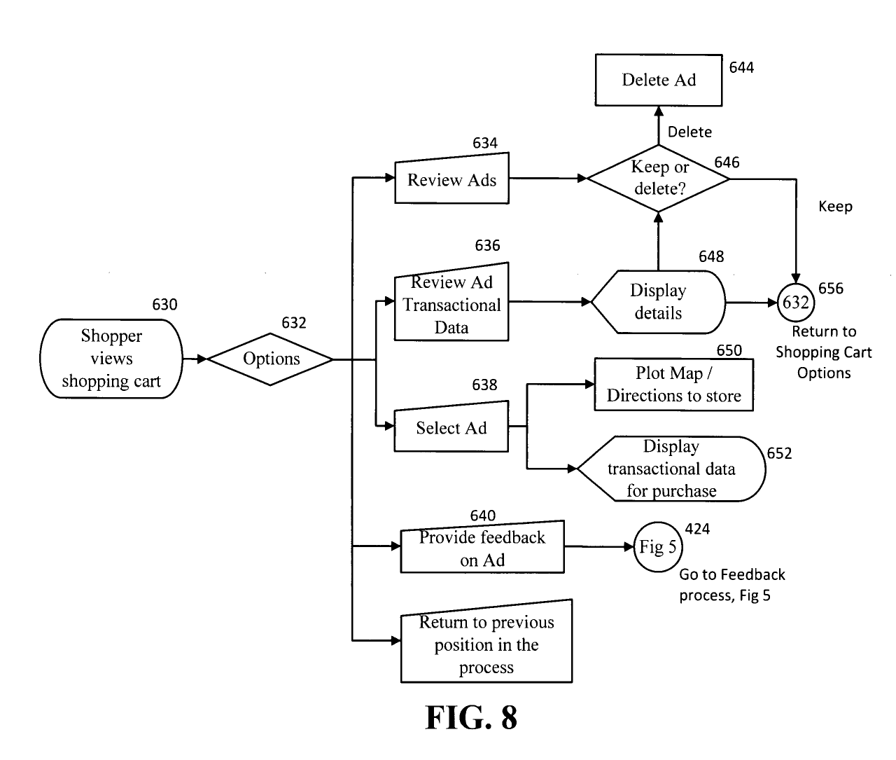

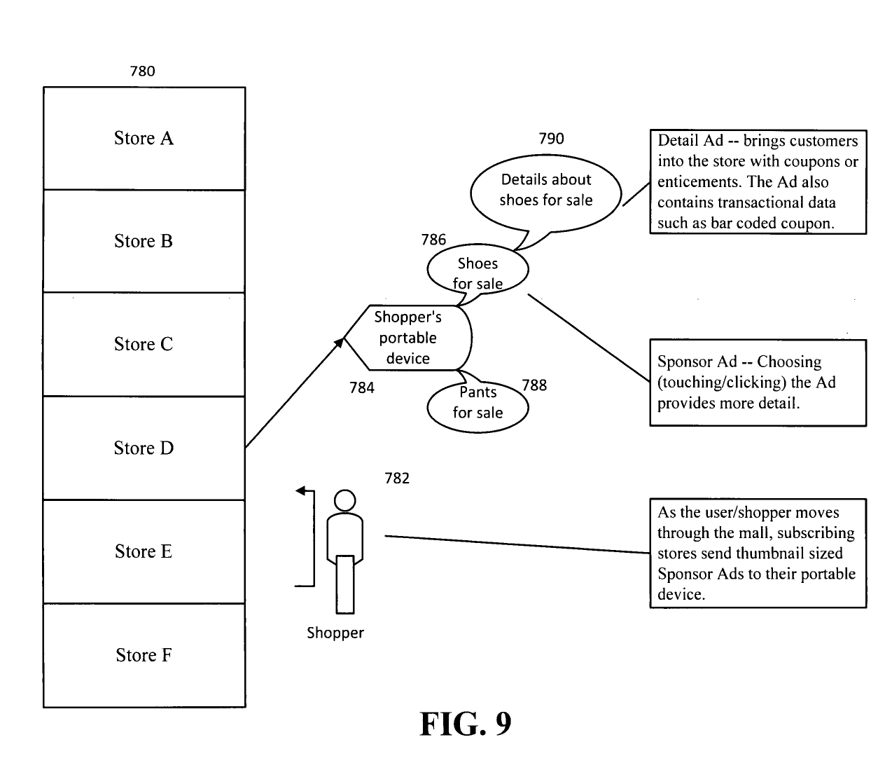

The differences with the Tier 2 level of access are:
Turn by turn directions cannot be provided unless a point of origin is known; therefore, the system may employ signage or store numbers or even store name look up to allow shoppers to plot a point of origin to a point of destination.
If no point of origin information is available, the mall maps can be displayed and centered on the desired store's location. The output is similar to looking up a single location on mapping programs such as Google® Maps or MapQuest®—a marker on the map shows the store's location with navigation controls allowing the user to move the map around and zoom in/out.
Upon loading a mall, the user can do nothing 546 or use the map functionality previously described 384.
Feedback—The feedback process covered in FIG. 5 will function like the kiosk except that information will not be cleared after a time period. The feedback data will be stored in the user's profile 456 and used for shaping the Ads received in the future.
“Save for Later” or “Save Ad to Shopping Cart”—Tier 2 and Tier 3 will provide “shopping cart” functionality to allow portable device shoppers to save Ads for later use/recall. During the search process, users can opt to store Ad information 580, while they perform other searches. As shown in FIG. 8, the user can recall these Ads easily 630 when they are completing their purchase in order to take advantage of the offer 652. For example, if the offer is a coupon, the bar code for the Ad's promotional offer can be displayed to make redemption easier. At any point in the process a user can pull up their shopping cart and perform a number of functions 632.
   Review existing stored Ads 634 and decide 646 if they want to keep 646 or delete 644 them.
   Review all the details 648 associated with an Ad via its transactional data 636. The user can also decide 646 if they want to keep 646 or delete 644 Ads at the transactional detail level as well.
   Select an Ad and retrieve its bar coded coupon for a purchase 652 or plot directions to that store 650.
   Provide feedback on the ad 640, 424.
   Return to wherever the user was before viewing their shopping cart 642.
Upon completion of a sales transaction 436, the user may plot wayfinding to their next purchase 650. Referring back to FIGS. 9A-9D, the user may also leave happy 438 or continue shopping by performing more searches 404 or by retrieving the shopping cart 610 and plotting wayfinding to their next purchase 650.

Advertising

Broadcast Ad—Mobile devices may also display Broadcast Ads as the mall directory/map is initially loading.

Portable device—Sponsor Ads, Detail Ads and Transactional data will function like their kiosk counterparts.

Metrics

Portable device metrics provided to advertisers can include the same metrics as the kiosks with the addition of: Activity levels and types of electronic portable devices.

Tier 3—Portable Device with Mall's Proximity WLAN

Engaging the System

A mobile user can select and load the Mall's directory and maps on their portable device using the previous methods discussed in Tier 2 access. But, when a Mall has a proximity based WLAN in place, the process can be even simpler. The mobile browser APP or the dedicated APP can detect the Mall's WLAN 504 and ask the user if they want to join 510.

Joining the proximity WLAN not only provides the user faster access to information, it also allows Proximity based Content to be delivered to the portable device in addition to the Search based Content. Also, Wayfinding information, like an indoor GPS, can be provided to the user for “turn-by-turn” navigation through the mall.

As shown in FIG. 9 with the Proximity based Content, as the shopper 782 walks the mall, the APP begins to receive Sponsor Ads 786, 788 to the user's portable device 784 and alert the user with a vibration or other type of alert. As previously discussed, the shopper can review the Detail Ads 790 and have all the search, feedback, and shopping cart functionality at their disposal with the addition of proximity based targeted advertising.

Search/Wayfinding

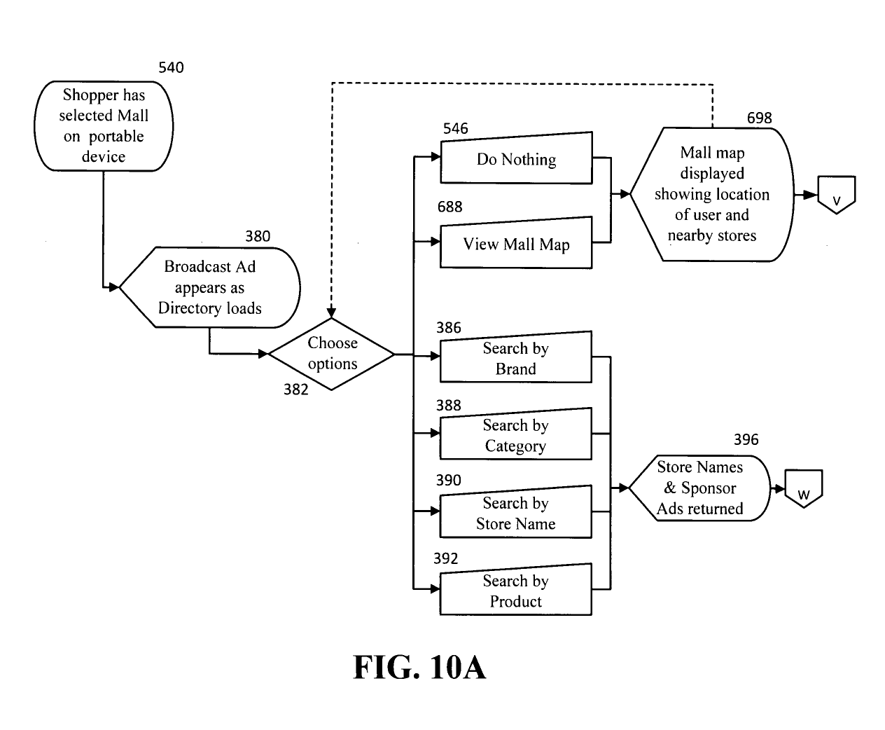

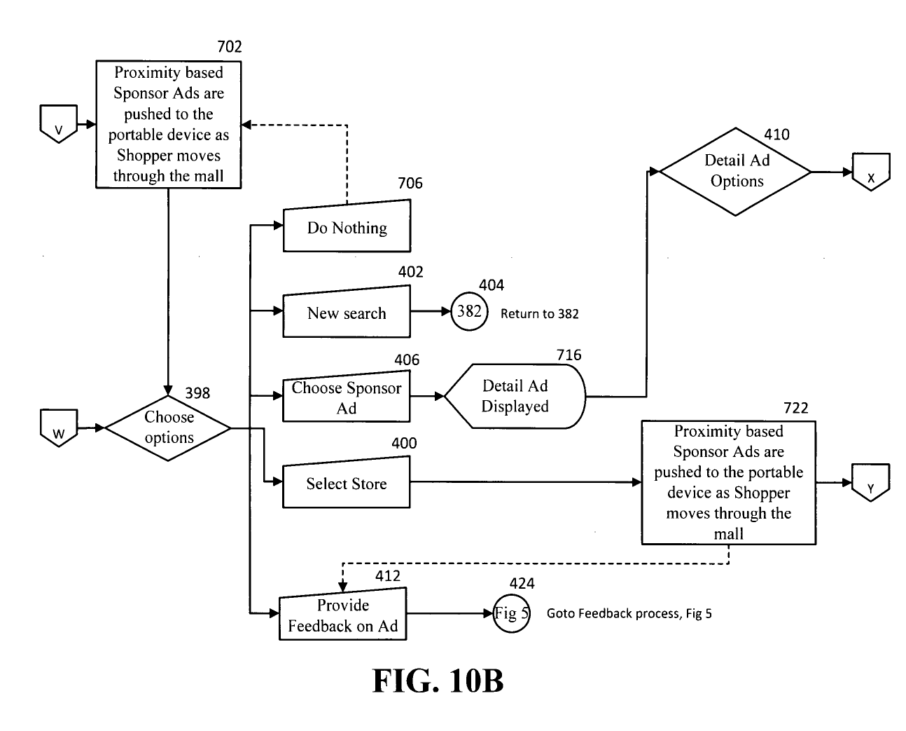

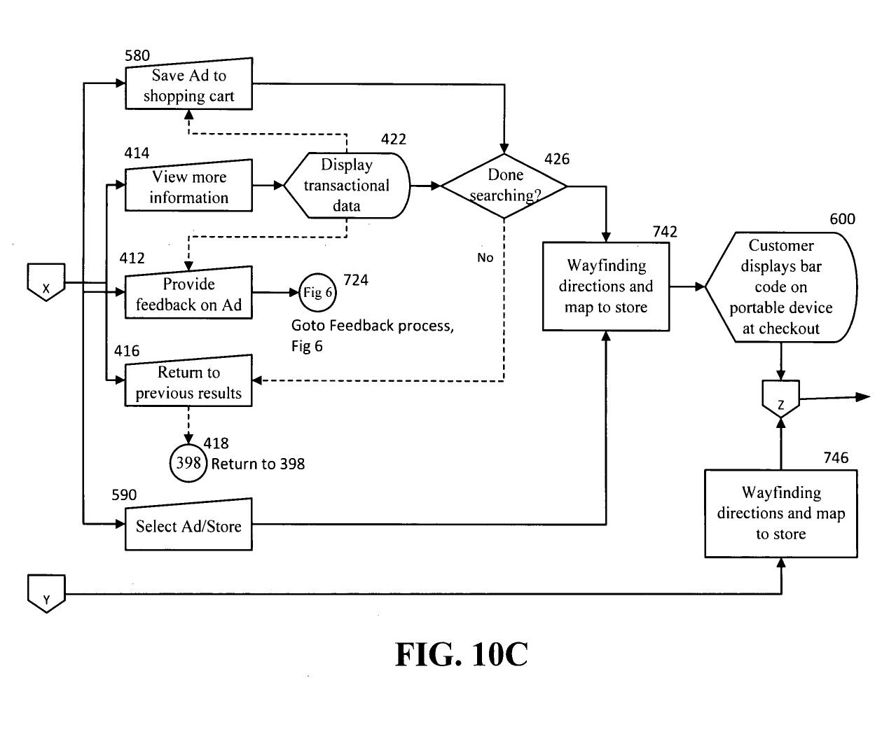

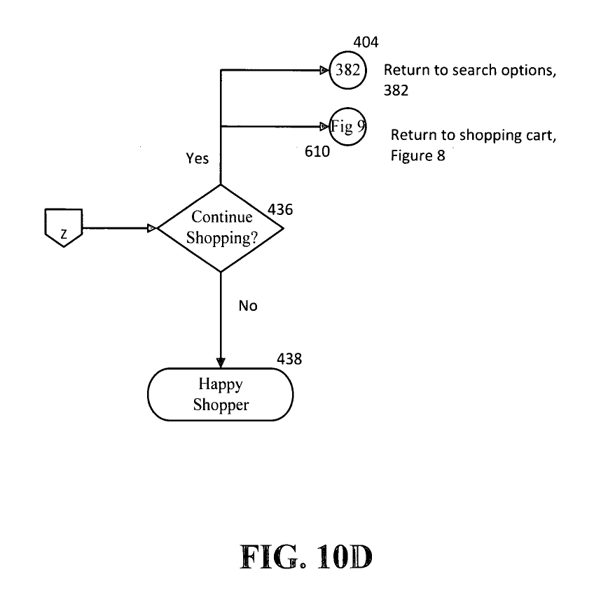

As shown in FIGS. 10A, 10B, 10C and 10D, the user experience with searching, Ad interaction, feedback, Ad shopping cart will be the same as a Tier 2 Portable device but with the additional functionality provided by the proximity based WLAN. Items previously discussed with reference to FIGS. 7A-7D for Tier 2 access will not be rediscussed even though they may appear in FIGS. 10A-10D.

The user can perform no searches 546 or 688 and simply use the service to provide a reference point for where they are in the mall—a constantly updated “you are here.”

“Proximity based Content”—Location based Ads 702, 722 and Map are pushed to the portable device as the user moves through the mall.

“Wayfinding” instead of “Mapping”—There is no need for determining a “point of origin” as in Tier 2 in order to get wayfinding directions. All maps will be location sensitive 698. Clicking a listed/highlighted store and a wayfinding map and directions are provided. The output is like the “driving directions” on mapping programs such as Google® Maps or MapQuest®—an arrow points on the mall map shows the way route to the store's location from the user's present location along with simple directions. The map and directions are updated as the user moves through the mall.

Additionally, in an alternative embodiment, users could use the proximity based

LAN to locate each other. For example, if everyone in a group has a mobile device, they could link their accounts/devices to easily locate each other. This could be especially helpful for parents shopping with kids. In yet another embodiment, parents could receive alerts if their children's devices are detected leaving the mall before the parents leave.

Advertising

Portable device Ads behave the same way with the exception that Proximity based Ads are pushed to the mobile device as the user moves through the mall.

Metrics

Portable device metrics provided to advertisers include but are not limited to the same metrics as listed in the Tier 2 access: The presence of a Proximity based WLAN can provide additional metrics that include but are not be limited to:
Mall traffic flow of those with Wi-Fi enabled portable devices
Time shoppers spend in stores.
Time shoppers spend in stores when using Ads from the system.

### System Architecture

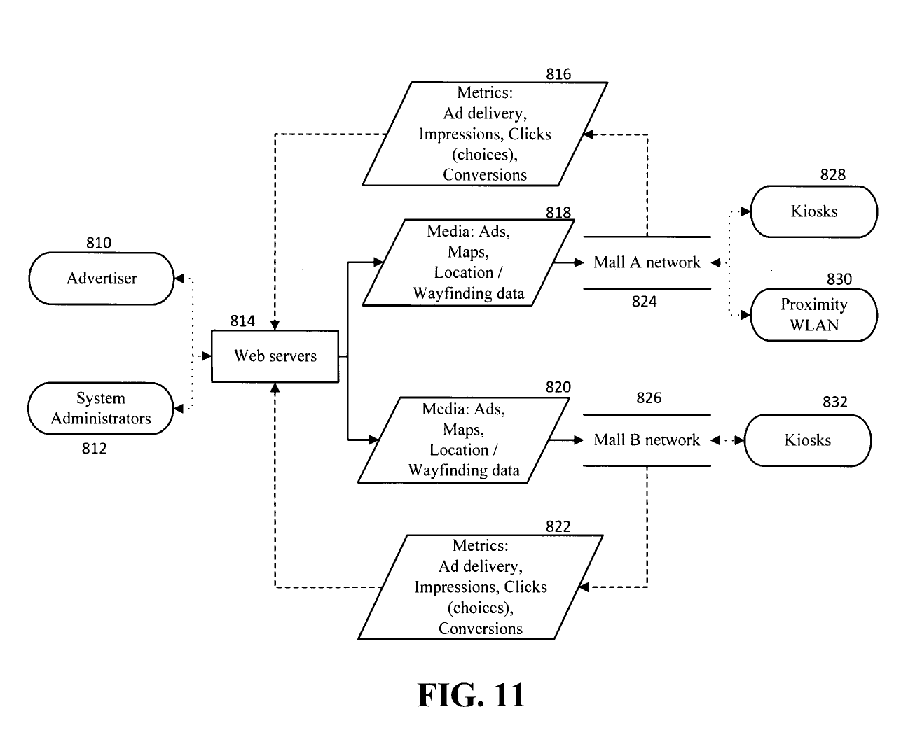

As shown in FIG. 11, the system architecture is specifically designed to be simple. Advertisers 810 and system administrators 812 will log in to the website 814 and manage campaigns across multiple malls from their account. Ads, content for the campaigns, maps and directory data 818, 820 will be pushed to the malls 824, 826 of their choice and those malls will provide metrics back to the website for the advertiser and system administrators to review. Additionally, the Mall metrics may be tied into the advertiser's current web metrics system.

Each individual mall 824, 826 will have a network built using standard industry practices that are best for that particular mall's needs whether they have a Tier 1 installation with just kiosks 832 or Tier 3 with kiosks and a proximity-based WLAN 828, 832. Whenever possible, advertising, directory, and maps will be pushed from within the mall's LAN to ensure the fastest delivery (because of increased bandwidth). Portable device users, such as those on Tier 2, who are not on a mall's proximity-based WLAN and are accessing the system via their mobile provider's Internet service, will pull their data from the website. If they are on a non-proximity based WLAN then an effort will be made to pull all media from the local LAN rather than the website.

The website will use standard web-based practices and be designed to evolve with emerging web technologies. The Ads will support standard communication mediums chosen and optimized for the particular content's bandwidth needs. This includes text, graphics, audio and/or video, and/or Flash animation. As Web delivery technologies evolve, different mediums may be integrated.

More advanced or larger advertisers may use an API (Application Programming Interface) for integrating existing internal register and transaction recording systems with the mall advertisement system to track entire purchase cycles from advertising to coupons redeemed at the transaction.

### Ad Management and Approval

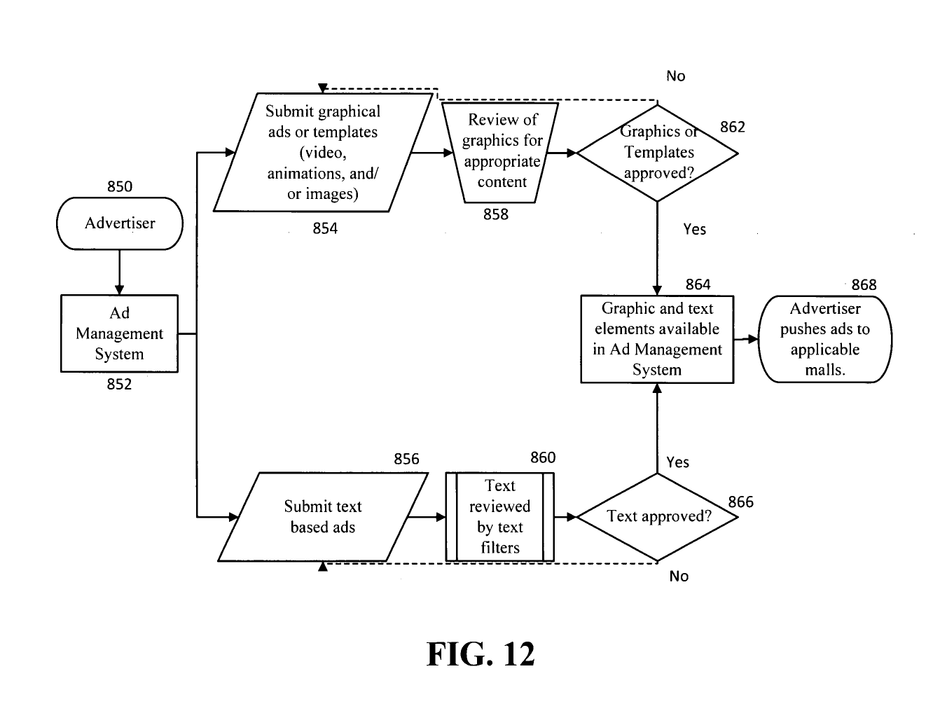

As shown in FIG. 12, the Ad management system 852, which allows advertisers 850 to manage their campaigns and receive metrics. The Ad management system can also employ an approval process for the Ad content if the conditions warrant.

To ensure the most timely and efficient management process, advertising content may be broken into two areas: text based content 856 and graphical/visual content 854. Text in ads can be automatically filtered for appropriate content 860. It is preferred that any graphical or visual elements be reviewed by system administrators for appropriate content until technology is available for automation of this step 858. When graphical content is approved 864 it will be available for the advertiser to push to the various mall locations 868.

This two-part system will allow advertisers to constantly change text based portions of messaging while using graphics/visual content that have already been approved.

In addition to the foregoing embodiments, any or all of the information assimilated and gathered above, could be used to populate one or more websites to provide the client with a more traditional website. By leveraging the information already gathered, the overall value to the client is significantly increased because the client/mall/retail location does not need to engage a separate company to re-gather information and create a traditional website. This provides yet another advantage to the client/mall/retail location by lowering cost and time to market.

The detailed description set forth above in connection with the appended drawings is intended as a description of exemplary embodiments in which the presently disclosed subject matter can be practiced. The detailed description includes specific details for providing a thorough understanding of the presently disclosed subject matter. However, it will be apparent to those skilled in the art that the presently disclosed process may be practiced without these specific details. In some instances, well-known structures and devices are shown in block diagram form in order to avoid obscuring the concepts of the presently disclosed subject matter.

It is to be further understood, therefore, that numerous changes in the details of the embodiments of the disclosed subject matter and additional embodiments will be apparent to, and may be made by, persons of ordinary skill in the art having reference to this description. It is contemplated that all such changes and additional embodiments are within the spirit and true scope of this disclosed subject matter as may be claimed.

The foregoing description of the preferred embodiments is provided to enable any person skilled in the art to make or use the claimed subject matter. Various modifications to these embodiments will be readily apparent to those skilled in the art, and the generic principles defined herein may be applied to other embodiments without the use of the innovative faculty. Thus, the subject matter is not intended to be limited to the embodiments shown herein but is to be accorded the widest scope consistent with the principles and novel features disclosed herein.

What is claimed is:

1. A method for distributing targeted advertising and intuitive wayfinding, the method comprising the steps of:
gathering information about one or more advertisers or brands, said information stored on a non-transitory computer readable medium and including at least one of:
standard retail center information found on websites associated with one or more of said advertisers; and
the location of each of said advertiser relative to other said advertisers; and/or
at least two locations within said retailer;
permitting said advertiser to provide advertisements via an advertising approval system, said advertisements associated with one or more of said advertisers and stored on said tangible non-transitory computer readable medium;
permitting said advertiser to manage distribution of said advertisements to desired retail locations through an advertising distribution system;
said advertising being targeted towards a particular shopper, said targeting comprising the following steps:
receiving said particular shopper's targeting data, said targeting data comprising one or more of the following:
search data, said search data received via a search interface;
pattern data, said particular shopper's pattern data including at least said particular shopper's purchase history;
proximity information;
analyzing said particular shopper's targeting data and based on said analysis identifying one or more advertisements targeted to said particular shopper;
delivering said one or more targeted advertisements to said particular shopper by mobile device or stationary kiosk;
locating a customer and providing said advertisements to said customer when said customer is within a preset distance from said associated retailer; and
charging said advertiser a fee.

2. The method of claim 1, wherein said fee is shared with at least one of:
a management company; and
an owner of said retail center.

3. The method of claim 1, wherein said fee is set through an auction or bid style system.

4. The method of claim 3, wherein said fee is shared with at least one of:
a management company; and
an owner of said retail center.

5. The method of claim 4, said delivering said one or more targeted advertisements to said particular shopper by said stationary kiosk.

6. The method of claim 3, said delivering said one or more targeted advertisements to said particular shopper by said stationary kiosk.

7. The method of claim 1, said delivering said one or more targeted advertisements to said particular shopper by said stationary kiosk.
